(19) United States
(12) Patent Application Publication
(10) Pub. No.: US 2009/0267418 A1
(43) Pub. Date: Oct. 29, 2009

(54) SWITCH POWER SUPPLY AND ELECTRONIC DEVICE HAVING SAME

(76) Inventors: Lan-Shiung Lin, Taipei (TW); Yu-Cheng Shen, Taipei (TW); Chuan-Chang Chou, Taipei (TW)

Correspondence Address: BIRCH STEWART KOLASCH & BIRCH, PO BOX 747, FALLS CHURCH, VA, 22040-0747, US

(21) Appl. No.: 12/429,565

(22) Filed: Apr. 24, 2009

(30) Foreign Application Priority Data
Apr. 25, 2008 (TW) 097115401

(51) Int. Cl. H02J 9/00

(52) U.S. Cl. 307/66

(57) ABSTRACT

A switch power supply includes an AC/DC converter, a DC/DC converter, a battery charge-discharge switching circuit, and a detecting and controlling circuit. The AC/DC converter receives an input AC voltage and converts the input AC voltage into a DC voltage. The DC/DC converter converts the DC voltage into several working voltages required for operating the electronic device. The battery charge-discharge switching circuit is selectively connected to the AC/DC converter or the DC/DC converter and connected to the battery. The detecting and controlling circuit detects the input AC voltage. If the input AC voltage is abnormal, the detecting and controlling circuit issues a control signal to the battery charge-discharge switching circuit. In response to the control signal, the battery issues a discharge voltage to the DC/DC converter and the discharge voltage is converted into the working voltages by the DC/DC converter.

### FIELD OF THE INVENTION

The present invention relates to a switch power supply, and more particularly to a switch power supply for use in an electronic device to provide stable power required for operating the electronic device. The present invention also relates to an electronic device having such a switch power supply.

### BACKGROUND OF THE INVENTION

With increasing development of electronic industries, IC design and associated fabricating techniques are well established. Consequently, the new-generation personal computers have excellent performance and thus become essential data processing apparatuses in the digitalized and electronic societies. Due to the amazing computation capability of personal computers, personal computers are widely employed to process digitalized data such as sound effects, images or graphics. Since the communication techniques have experienced great growth, the users may search or download useful information and/or communicate with others through internet connection. In other words, personal computers have become indispensable tools in workplaces or daily lives, or otherwise used as leisure or amusement tools.

As known, a personal computer has a power supply within a case thereof in order to provide electricity for operating the internal components or the peripheral components of the personal computer. By means of the power supply, an input AC voltage from a utility power source is rectified and then converted into various working DC voltages required for operating the electronic components of the personal computer. In a case that the input AC voltage from the utility power source is subject to a sudden variation or interruption, the power supply fails to be normally operated and thus the personal computer may have a crash. Under this circumstance, some important data stored in the personal computer are possibly lost or some components of the personal computer are damaged.

For solving the above drawbacks, an uninterruptible power supply (UPS) is widely used to provide stable power to the personal computer. If the voltage of the utility power is subject to a sudden variation or interruption, the power to the personal computer could be maintained at an applicable level by using the UPS. As a consequence, the damage on the hardware components of the personal computer is minimized and the user has sufficient time to store the important data.

The use of the UPS, however, still has some drawbacks. For example, additionally purchasing the UPS is not cost-effective. In addition, the UPS occupies extra space and thus is adverse to space utilization. In views of space utilization and cost-effectiveness, the use of the UPS is disadvantageous.

Moreover, according to the operation principle of a typical UPS, the input AC voltage from the utility power source is converted into a DC voltage, which is then stored in the backup battery of the UPS. In a case that the input AC voltage from the utility power source is subject to a sudden variation or interruption, the DC voltage stored in the backup battery is inverted back to an inverted AC voltage to be supplied to the power supply of the personal computer. As known, the process of converting the input AC voltage into the DC voltage and then converting the DC voltage into the AC voltage is very complicated and thus usually results in unnecessary power loss.

Moreover, when the DC voltage stored in the backup battery is inverted back to the inverted AC voltage to be supplied to the power supply of the personal computer, it is important to synchronize the inverted AC voltage with the input AC voltage from the utility power source. If the inverted AC voltage and the input AC voltage are asynchronous, the phase change is abrupt when the UPS begins to power the computer system. Under this circumstance, the inverted AC voltage is unstable and thus the personal computer may have a crash.

### SUMMARY OF THE INVENTION

The present invention relates to a switch power supply for use in an electronic device to provide stable power required for operating the electronic device.

The present invention also relates to an electronic device having such a switch power supply.

In accordance with an aspect of the present invention, there is provided a switch power supply for use in an electronic device having a battery. The switch power supply includes an AC/DC converter, a DC/DC converter, a battery charge-discharge switching circuit, and a detecting and controlling circuit. The AC/DC converter receives an input AC voltage and converts the input AC voltage into a DC voltage. The DC/DC converter is electrically connected to the AC/DC converter for converting the DC voltage into several working voltages required for operating the electronic device. The battery charge-discharge switching circuit has a first terminal selectively connected to the AC/DC converter or the DC/DC converter and a second terminal connected to the battery. The detecting and controlling circuit is used for detecting the input AC voltage. If the input AC voltage is abnormal, the detecting and controlling circuit issues a control signal to the battery charge-discharge switching circuit, and in response to the control signal, the battery charge-discharge switching circuit is switched to a discharge state such that the battery issues a discharge voltage to the DC/DC converter and the discharge voltage is converted into the working voltages by the DC/DC converter.

In accordance with another aspect of the present invention, there is provided an electronic device. The electronic device includes a motherboard, a battery and a switch power supply. The switch power supply is electrically connected to a utility power source, the motherboard and the battery. The switch power supply includes an AC/DC converter, a DC/DC converter, a battery charge-discharge switching circuit, and a detecting and controlling circuit. The AC/DC converter receives an input AC voltage and converts the input AC voltage into a DC voltage. The DC/DC converter is electrically connected to the AC/DC converter for converting the DC voltage into several working voltages required for operating the electronic device. The battery charge-discharge switching circuit has a first terminal selectively connected to the AC/DC converter or the DC/DC converter and a second terminal connected to the battery. The detecting and controlling circuit is used for detecting the input AC voltage. If the input AC voltage is abnormal, the detecting and controlling circuit issues a control signal to the battery charge-discharge switching circuit, and in response to the control signal, the battery charge-discharge switching circuit is switched to a discharge state such that the battery issues a discharge voltage to the DC/DC converter and the discharge voltage is converted into the working voltages by the DC/DC converter.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is schematic circuit block diagram illustrating an electronic device having a switch power supply according to a preferred embodiment of the present invention; and

FIG. 2 is a schematic perspective view illustrating a switch power supply mounted within a personal computer.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

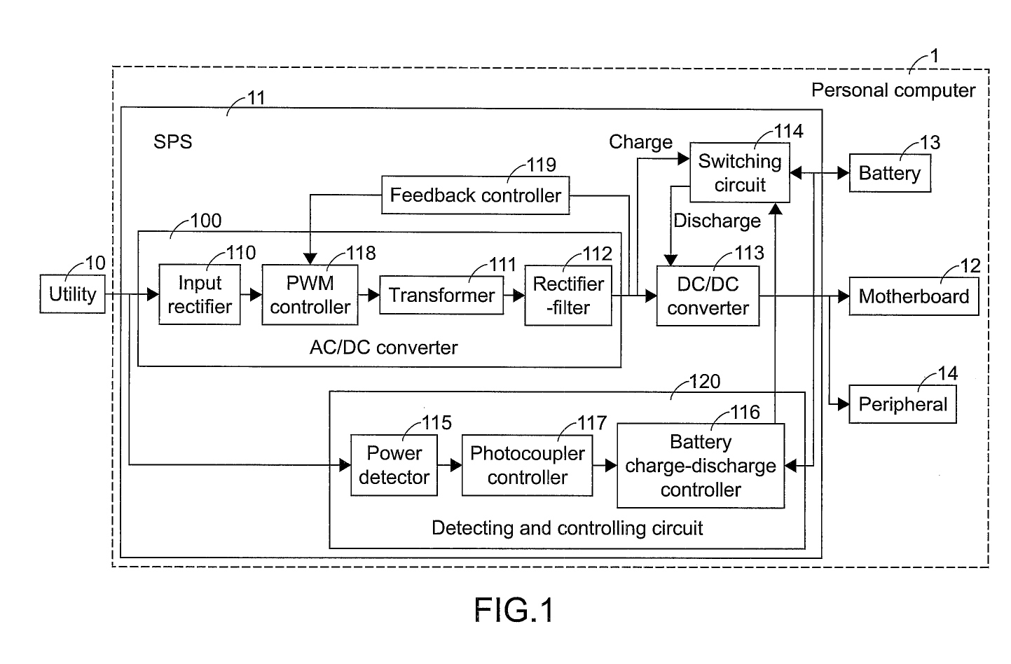

FIG. 1 is schematic circuit block diagram illustrating an electronic device having a switch power supply according to a preferred embodiment of the present invention. An example of the electronic device 1 is a personal computer. The switch power supply (SPS) 11 is electrically connected to a utility power source 10 for receiving an input AC voltage (e.g. 110V or 120V) from the utility power source 10. The switch power supply 11 is also electrically connected to a motherboard 12, one or more peripheral components 14 and a built-in battery 13 of the personal computer 1.

As shown in FIG. 1, the switch power supply 11 comprises an AC/DC converter 100, a DC/DC converter 113, a battery charge-discharge switching circuit 114 and a detecting and controlling circuit 120.

The AC/DC converter 100 principally comprises an input rectifier 110, an isolation transformer 111, a rectifier-filter circuit 112 and a pulse width modulation (PWM) controller 118. The input rectifier 110 is electrically connected to the utility power source 10 for receiving the input AC voltage and converting the input AC voltage into a DC voltage. The PWM controller 118 is electrically connected to the input rectifier 110 for adjusting the pulse duty cycle. The isolation transformer 111 is electrically connected to the PWM controller 118 for reducing the DC voltage into a low DC voltage. The rectifier-filter circuit 112 is electrically connected to the isolation transformer 111 for rectifying and filtering the low DC voltage, thereby providing a rectified and filtered DC voltage having a stable and specified voltage value. For example, the specified voltage value is ranged between 14 and 16 volts.

The DC/DC converter 113 is electrically connected to the rectifier-filter circuit 112 of the AC/DC converter 100 for converting the rectified and filtered DC voltage into several DC working voltages required for powering the motherboard 12 and the peripheral component 14. Generally, the working voltages required for various components of a computer system includes for example 3.3, 5 and 12 volts.

The battery charge-discharge switching circuit 114 is selectively connected to the AC/DC converter 100 or the DC/DC converter 113. In a case that the input AC voltage transmitted from the utility power source 10 is normal, the battery charge-discharge switching circuit 114 is switched to a charge state such that a charging path leading from the AC/DC converter 100 to the battery charge-discharge switching circuit 114 is conducted but the discharging path leading from the battery charge-discharge switching circuit 114 to the DC/DC converter 113 is shut off. Under this circumstance, the rectified and filtered DC voltage outputted from the rectifier-filter circuit 112 is transmitted to the battery 13 along the charging path so as to charge the battery 13. On the other hand, if the input AC voltage transmitted from the utility power source 10 is abnormal, the battery charge-discharge switching circuit 114 is switched to a discharge state such that the charging path is shut off but the discharging path is conducted. Under this circumstance, the battery 13 issues a discharge voltage to the DC/DC converter 113 along the discharging path. By the DC/DC converter 113, the discharge voltage is then converted into desired working voltages required for powering the motherboard 12 and the peripheral component 14.

The detecting and controlling circuit 120 has an input terminal for receiving and detecting the input AC voltage. In addition, the detecting and controlling circuit 120 has an output terminal electrically connected to the battery charge-discharge switching circuit 114. In a case that the input AC voltage detected by the detecting and controlling circuit 120 is abnormal (e.g. lower than a threshold value), the detecting and controlling circuit 120 issues a discharge control signal to the battery charge-discharge switching circuit 114. In response to the discharge control signal, the battery charge-discharge switching circuit 114 is switched to a discharge state such that the battery 13 issues a discharge voltage to the DC/DC converter 113 and the discharge voltage is converted into the working voltages by the DC/DC converter 113. On the other hand, if the input AC voltage transmitted from the utility power source 10 is normal, the detecting and controlling circuit 120 issues a charge control signal to the battery charge-discharge switching circuit 114. In response to the charge control signal, the battery charge-discharge switching circuit 114 is switched to a charge state such that the rectified and filtered DC voltage outputted from the AC/DC converter 100 is transmitted to the battery 13 along the charging path to charge the battery 13.

Please refer to FIG. 1 again. The detecting and controlling circuit 120 comprises a power detector 115, a battery charge-discharge controller 116 and a photocoupler controller 117. The power detector 115 is electrically connected to the utility power source 10 for detecting the input AC voltage, thereby generating a detecting signal. The battery charge-discharge controller 116 is electrically connected to the battery charge-discharge switching circuit 114. In response to the detecting signal generated by the power detector 115, the battery charge-discharge controller 116 issues a corresponding control signal to the battery charge-discharge switching circuit 114. The photocoupler controller 117 is electrically interconnected between the power detector 115 and the battery charge-discharge controller 116 for providing electrical isolation and transmitting the detecting signal.

If the input AC voltage detected by the power detector 115 is abnormal (e.g. lower than the threshold value), the battery charge-discharge controller 116 issues a discharge control signal to the battery charge-discharge switching circuit 114. In response to the discharge control signal, the battery charge-discharge switching circuit 114 is switched to a discharge state such that the battery 13 issues a discharge voltage to the DC/DC converter 113. On the other hand, if the input AC voltage detected by the power detector 115 is maintained stable and greater than the threshold value (i.e. at the normal state), the battery charge-discharge controller issues a charge control signal to the battery charge-discharge switching circuit 114. In response to the charge control signal, the battery charge-discharge switching circuit 114 is switched to a charge state such that the rectified and filtered DC voltage outputted from the AC/DC converter 100 is transmitted to the battery 13 along the charging path to charge the battery 13.

Please refer to FIG. 1 again. The switch power supply 11 further comprises a feedback controller 119. The feedback controller 119 is electrically interconnected between the rectifier-filter circuit 112 and the PWM controller 118. According to the rectified and filtered DC voltage outputted from the rectifier-filter circuit 112, the feedback controller 119 issues a feedback signal to the PWM controller 118 so as to perform feedback control.

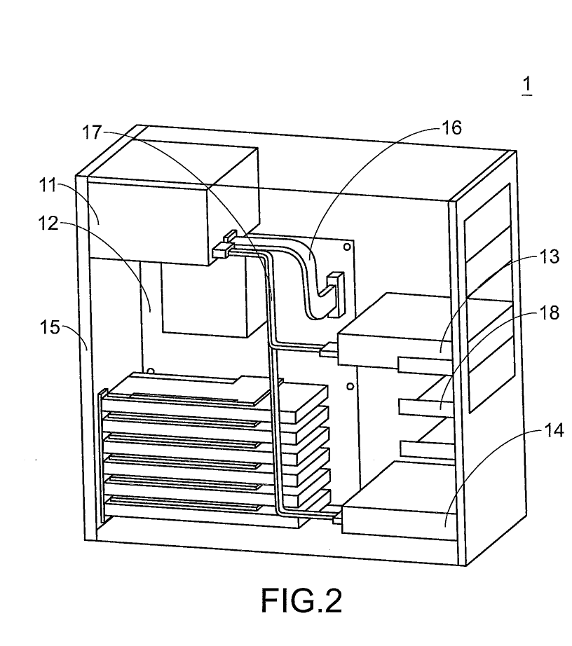

FIG. 2 is a schematic perspective view illustrating a switch power supply mounted within a personal computer. In the personal computer 1 as shown in FIG. 2, the switch power supply 11, the motherboard 12, a battery 13 and the peripheral component 14 are mounted within a computer case 15. For example, the computer case 15 is an ATX case or a mATX case.

The switch power supply 11 is electrically connected to the utility power source through a cable (not shown) for receiving the input AC voltage and converting the input AC voltage into various DC voltages required for operating the electronic components of the personal computer. The switch power supply 11 is arranged at the upper and rear side of the internal portion of the computer case 15. An exemplary switch power supply 11 includes but is not limited to an ATX power supply, a SFX power supply or a TFX power supply. The motherboard 12 is arranged under the switch power supply 11. Via a power wire 16, the motherboard 12 is electrically connected to the switch power supply 11 for acquiring desired working voltage outputted from the switch power supply 11.

Furthermore, several peripheral component receptacles 18 are disposed within the computer case 15 for accommodating peripheral components 14. The peripheral components 14 include for example a hard disc, an optical disc drive, a disc burner or the like. Via another power wire 17, these peripheral components 14 are electrically connected to the DC/DC converter 113 of the switch power supply 11 for acquiring desired working voltage outputted from the switch power supply 11. The battery 13 used in the personal computer 1 of the present invention includes for example a lead acid battery, a lithium ion battery, a fuel battery or a nickel metal hydride battery.

From the above description, the switch power supply of the present invention is capable of charging a battery of a personal computer. In a case that the input AC voltage from a utility power source is subject to a sudden variation or interruption, the DC voltage stored in the battery can be converted into working voltages required for powering the personal computer. As a consequence, the damage on the hardware components of the personal computer is minimized and the user has sufficient time to store the important data. In other words, the switch power supply of the present invention may provide stable power required for operating the electronic device without the need of additionally purchasing a UPS. Moreover, since the DC voltage stored in the battery is converted into the working voltages when the input AC voltage is abnormal, the problem of causing abrupt phase change and unstable voltage encountered from the prior art will be overcome.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A switch power supply for use in an electronic device having a battery, the switch power supply comprising:
an AC/DC converter for receiving an input AC voltage and converting the input AC voltage into a DC voltage;
a DC/DC converter electrically connected to the AC/DC converter for converting the DC voltage into several working voltages required for operating the electronic device;
a battery charge-discharge switching circuit having a first terminal selectively connected to the AC/DC converter or the DC/DC converter and a second terminal connected to the battery; and
a detecting and controlling circuit for detecting the input AC voltage, wherein if the input AC voltage is abnormal, the detecting and controlling circuit issues a control signal to the battery charge-discharge switching circuit, and in response to the control signal, the battery charge-discharge switching circuit is switched to a discharge state such that the battery issues a discharge voltage to the DC/DC converter and the discharge voltage is converted into the working voltages by the DC/DC converter.

2. The witch power supply according to claim 1 wherein the input AC voltage is abnormal if the input AC voltage is lower than a threshold value.

3. The witch power supply according to claim 1 wherein the input AC voltage is provided by a utility power source.

4. The witch power supply according to claim 1 wherein the detecting and controlling circuit comprises:
a power detector for detecting the input AC voltage, thereby generating a detecting signal;
a photocoupler controller electrically connected to the power detector for transmitting the detecting signal; and
a battery charge-discharge controller electrically connected to the photocoupler controller and the battery charge-discharge switching circuit, wherein the battery charge-discharge controller issues the control signal to the battery charge-discharge switching circuit in response to the detecting signal.

5. The witch power supply according to claim 1 wherein the AC/DC converter comprises:
an input rectifier;
a pulse width modulation controller electrically connected to the input rectifier;
an isolation transformer electrically connected to the pulse width modulation controller; and
a rectifier-filter circuit electrically connected to the isolation transformer for outputting the DC voltage to the DC/DC converter.

6. The witch power supply according to claim 5 wherein the witch power supply further comprises a feedback controller interconnected between the rectifier-filter circuit and the pulse width modulation controller.

7. The witch power supply according to claim 1 wherein if the input AC voltage is normal, the battery charge-discharge switching circuit is switched to a charge state such that the DC voltage is transmitted from the AC/DC converter to the battery for charging the battery.

8. An electronic device comprising:
a motherboard;
a battery; and
a switch power supply electrically connected to a utility power source, the motherboard and the battery, and comprising:
an AC/DC converter for receiving an input AC voltage issued by the utility power source and converting the input AC voltage into a DC voltage;
a DC/DC converter electrically connected to the AC/DC converter for converting the DC voltage into several working voltages required for operating the electronic device;
a battery charge-discharge switching circuit having a first terminal selectively connected to the AC/DC converter or the DC/DC converter and a second terminal connected to the battery; and
a detecting and controlling circuit for detecting the input AC voltage, wherein if the input AC voltage is abnormal, the detecting and controlling circuit issues a control signal to the battery charge-discharge switching circuit, and in response to the control signal, the battery charge-discharge switching circuit is switched to a discharge state such that the battery issues a discharge voltage to the DC/DC converter and the discharge voltage is converted into the working voltages by the DC/DC converter.

9. The electronic device according to claim 8 wherein the input AC voltage is abnormal if the input AC voltage is lower than a threshold value.

10. The electronic device according to claim 8 wherein the input AC voltage is provided by a utility power source.

11. The electronic device according to claim 8 wherein the detecting and controlling circuit comprises:
a power detector for detecting the input AC voltage, thereby generating a detecting signal;
a photocoupler controller electrically connected to the power detector for transmitting the detecting signal; and
a battery charge-discharge controller electrically connected to the photocoupler controller and the battery charge-discharge switching circuit, wherein the battery charge-discharge controller issues the control signal to the battery charge-discharge switching circuit in response to the detecting signal.

12. The electronic device according to claim 8 wherein the AC/DC converter comprises:
an input rectifier;
a pulse width modulation controller electrically connected to the input rectifier;
an isolation transformer electrically connected to the pulse width modulation controller; and
a rectifier-filter circuit electrically connected to the isolation transformer for outputting the DC voltage to the DC/DC converter.

13. The electronic device according to claim 12 wherein the witch power supply further comprises a feedback controller interconnected between the rectifier-filter circuit and the pulse width modulation controller.

14. The electronic device according to claim 8 wherein if the input AC voltage is normal, the battery charge-discharge switching circuit is switched to a charge state such that the DC voltage is transmitted from the AC/DC converter to the battery for charging the battery.

15. The electronic device according to claim 8 wherein the electronic device is a personal computer that has a case for enclosing the motherboard, the battery and the switch power supply, and a peripheral component receptacle is mounted within the case for accommodating the battery.

16. The electronic device according to claim 15 wherein at least one peripheral component is disposed within the case and electrically connected to the DC/DC converter of the switch power supply.

17. The electronic device according to claim 16 wherein the peripheral component includes a hard disc, an optical disc drive or a disc burner.

18. The electronic device according to claim 16 wherein the battery is a lead acid battery, a lithium ion battery, a fuel battery or a nickel metal hydride battery.
